(19) United States
(12) Patent Application Publication
(10) Pub. No.: US 2009/0293283 A1
(43) Pub. Date: Dec. 3, 2009

(54) Combined Soup Spoon And Dinner Knife

(76) Inventor: Wen-Hsiung Hsu, Taipei City (TW)

Correspondence Address: FRENKEL & ASSOCIATES, 3975 UNIVERSITY DR., STE. 330, FAIRFAX, VA, 22030, US

(21) Appl. No.: 12/129,771

(22) Filed: May 30, 2008

(51) Int. Cl. A47J 43/28

(52) U.S. Cl. 30/149

(57) ABSTRACT

A combined soup spoon and dinner knife includes a handle and a shallow bowl connected to a front end of the handle for lifting, serving, or eating food; and the shallow bowl is provided along the lower right and left sides with an edge of serrated teeth for cutting food. Both right-handed users and left-handed users may conveniently use the shallow bowl to eat soup or cut food by holding at the handle with the right hand or left hand.

### FIELD OF THE INVENTION

The present invention relates to a piece of cutlery, and more particularly to a combined soup spoon and dinner knife that can be used to eat soup and cut food.

### BACKGROUND OF THE INVENTION

A general soup spoon A as shown in FIG. 1 includes a shallow bowl A1 for eating soup and a handle A2 connected to the shallow bowl A1. A user may hold the soup spoon A at the handle A2 with one hand. The soup spoon A is designed to provide only one simple function of lifting, serving, or eating food.

And, a general dinner knife (not shown) includes a flat blade and a handle connected to the blade. The handle may be differently shaped, and the blade has a serrated edge for cutting meat or other kinds of food. Therefore, the dinner knife is also designed to provide a very simple function of cutting food.

There is also a conventional combined soup spoon and dinner knife (not shown), which includes a handle, which is connected at an end to a shallow bowl for lifting and eating soup, and at the other hand to a serrated blade to serve as a dinner knife for cutting food. The shallow bowl and the serrated blade separately connected to the two ends of the handle have one single specific function of eating soup and cutting food, respectively.

### SUMMARY OF THE INVENTION

A primary object of the present invention is to provide a combined soup spoon and dinner knife that can be used by both right-handed and left-handed users to eat soup and cut food conveniently.

To achieve the above and other objects, the combined soup spoon and dinner knife of the present invention includes a handle and a shallow bowl connected to a front end of the handle for lifting, serving, or eating food; and the shallow bowl is serrated at the opposed sides of the bowl for cutting.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a general soup spoon;

FIG. 2 is a perspective view of a combined soup spoon and dinner knife according to a preferred embodiment of the present invention;

FIG. 2A is an enlarged view of the circled area of FIG. 2; and

FIG. 3 shows the use of the combined soup spoon and dinner knife to cut food.

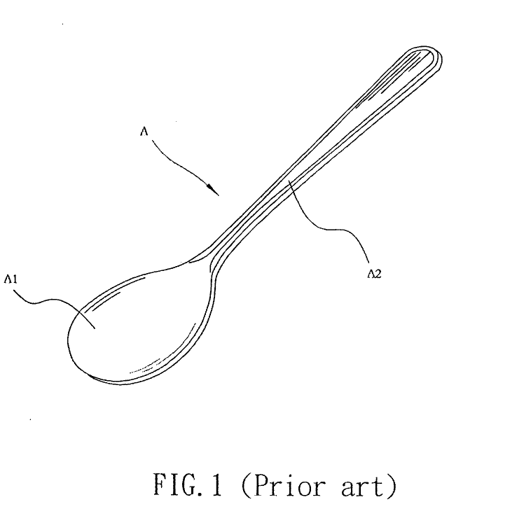

### DETAILED DESCRIPTION OF THE PREFERRED EMBODIMENTS

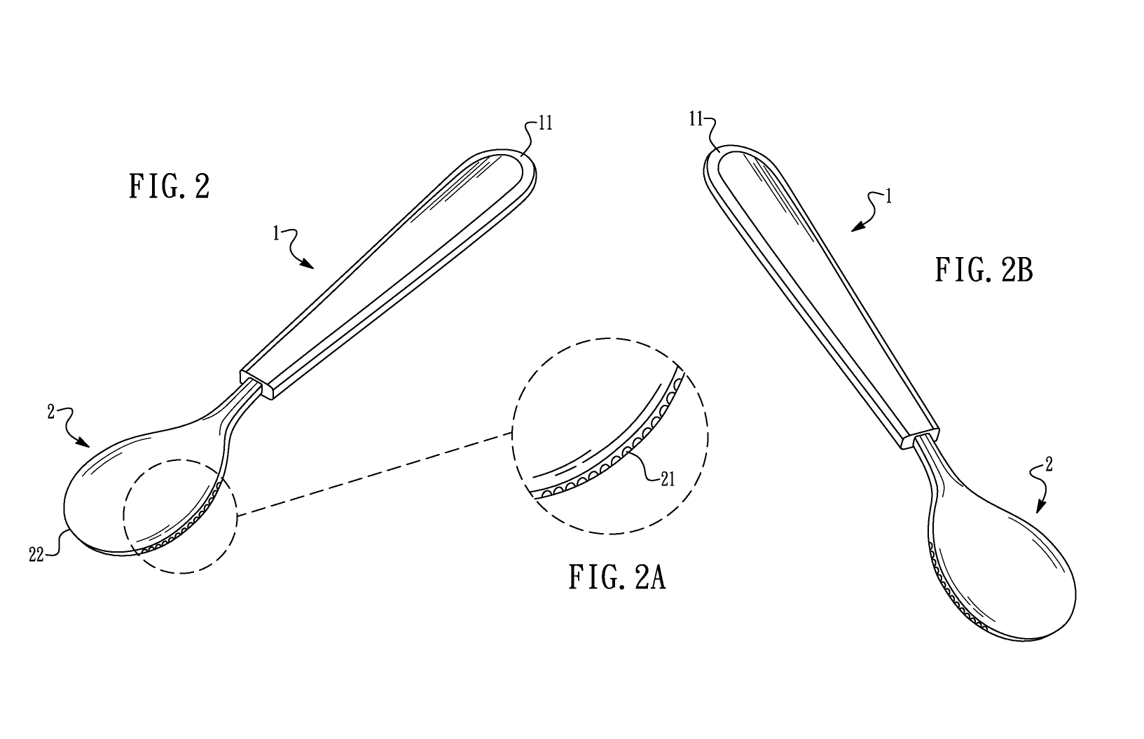

Please refer to FIGS. 2 and 2A. According to a preferred embodiment of the present invention, a combined soup spoon and dinner knife includes a handle 1 for holding by a user, and a shallow bowl 2 connected to a front end of the handle 1 for lifting, serving, or eating soup or food. The shallow bowl 2 is provided at lower right and left sides with serrated teeth 21 each for cutting food. Herein, the right and left sides of the shallow bowl 2 are corresponding to a user's right and left hands, respectively, when the shallow bowl 2 is positioned with its front end pointing forward and its recessed side facing upward.

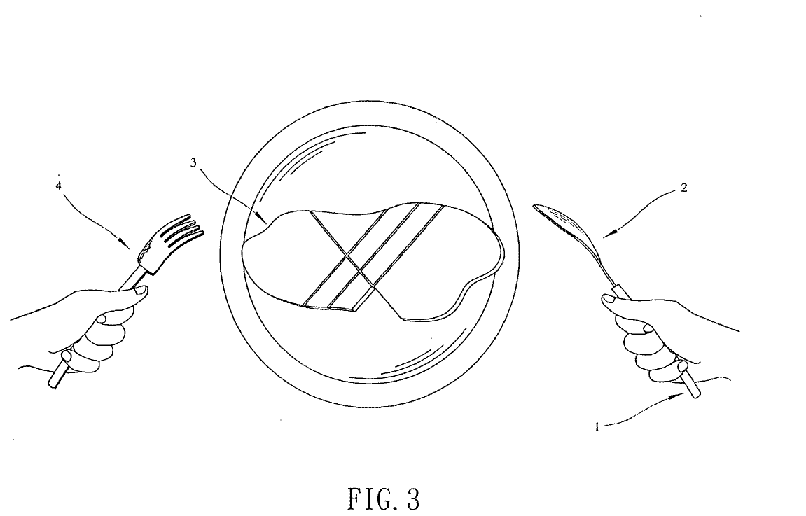

FIG. 3 generally shows the use of the combined soup spoon and dinner knife of the present invention. Please refer to FIGS. 2 and 3 at the same time. When a right-handed user holds the combined soup spoon and dinner knife of the present invention with the right hand to cut food 3, the user may hold a fork 4 with the left hand to hold the food 3 in place. The right-handed user may hold the combined soup spoon and dinner knife with the recessed side of the shallow bowl 2 facing inward, and uses the serrated edge 21 at the lower left side of the shallow bowl 2 to cut the food 3. The user may put the shallow bowl 2 close to the fork 4, so that one small piece for just one bite may be cut and separated from the food 3. While cutting, the combined soup spoon and dinner knife automatically moves closer to the fork 4.

Alternatively, the right-handed user may hold the handle 1 of the combined soup spoon and dinner knife with the right hand for the recessed side of the shallow bowl 2 to face outward, so as to use the serrated edge 21 at the lower right side of the shallow bowl 2 to cut the food 3. In this manner, the food 3 may be sequentially cut into multiple separated small pieces. That is, the user holds the fork 4 with the left hand to hold the food 3 in place, and uses the right serrated edge of the shallow bowl 2 to start cutting the food 3 at a point distant from the fork 4. While cutting, the combined soup spoon and dinner knife automatically slides outward to separate a small piece from the rest of the food 3.

On the other hand, when a left-handed user holds the fork 4 with the right hand and holds the handle 1 of the combined soup spoon and dinner knife with the left hand to cut the food 3, the user may hold the combined soup spoon and dinner knife with the recessed side of the shallow bowl 2 facing inward, so as to use the serrated edge 21 at the lower right side of the shallow bowl 2 to cut the food 3. In this position, one small piece for just one bite may be cut and separated from the food 3. Alternatively, the user may hold the combined soup spoon and dinner knife with the recessed side of the shallow bowl 2 facing outward, so as to use the serrated edge 21 at the lower left side of the shallow bowl 2 to cut the food 3. In this position, the food 3 may be sequentially cut into multiple separated small pieces from the outer to inner sides of the food 3.

The shallow bowl 2 has a front edge 22 continuously extended between the right and left serrated edges 21. Since the front edge 22 is seldom used during cutting food, and to avoid a user's mouth from being injured when using the serrated shallow bowl 2 to eat soup, the front edge 22 of the shallow bowl 2 is maintained as smooth as general spoons.

The serrated edges 21 at the lower right and left sides of the shallow bowl 2 cover an area always smaller than an area covered by the lower right or left side of the shallow bowl 2. Therefore, while the serrated edges 21 at the lower right and left sides of the shallow bowl 2 allow the shallow bowl 2 to cut food 3, they do not form a risk of injuring a user when eating soup with the shallow bowl 2.

The handle 1 of the combined soup spoon and dinner knife of the present invention includes a rear end formed into an expanded head portion 11 with a curved configuration. The handle 1 is tapered from the expanded head portion 11 toward the front end of the handle 1. With the expanded head portion 11 having a curved configuration, a user may apply force more easily without hurting the user's palm while holding the handle 1 to cut the food 3.

In the present invention, the handle 1 and the shallow bowl 2 are integrally formed to thereby have enhanced structural strength between them.

The present invention has been described with a preferred embodiment thereof, and it is understood that many changes and modifications in the described embodiment can be carried out without departing from the scope and the spirit of the invention that is intended to be limited only by the appended claims.

1. A combined soup spoon and dinner knife, comprising: a handle, and a shallow bowl connected to a front end of the handle for lifting, serving, or eating food; and the shallow bowl being provided along lower right and left sides with serrated teeth for cutting food, said shallow bowl including a front smooth edge continuously extending between the right and left serrated edges.

2. (canceled)

3. The combined soup spoon and dinner knife as claimed in claim 1, wherein the serrated edges at the lower right and left sides of the shallow bowl cover an area always smaller than an area covered by the lower right or left side of the shallow bowl.

4. The combined soup spoon and dinner knife as claimed in claim 1, wherein the handle includes a rear end formed into an expanded head portion.

5. The combined soup spoon and dinner knife as claimed in claim 4, wherein the handle is tapered from the expanded head portion toward the front end thereof.

6. The combined soup spoon and dinner knife as claimed in claim 4, wherein the expanded head portion has a curved configuration.

7. The combined soup spoon and dinner knife as claimed in claim 1, wherein the handle and the shallow bowl are integrally formed.
